(19) United States
(12) Patent Application Publication
(10) Pub. No.: US 2005/0217118 A1
(43) Pub. Date: Oct. 6, 2005

(54) Magnet based angular force control

(76) Inventor: Pat Y. Mah, Cheung Sha Wan (HK)

Correspondence Address: Curtis L. Harrington, Suite 250, 6300 State University Drive, Long Beach, CA, 90815, US

(21) Appl. No.: 10/817,254

(22) Filed: Apr. 1, 2004

(51) Int. Cl. B26B 13/00

(52) U.S. Cl. 30/261

(57) ABSTRACT

A scissors set includes magnetic elements to provide the force to open the scissor members, and are particularly useful for miniature, multi-tool use. The scissors disclosed herein use magnets to provide the force of separation. Opposing same-polarity magnets provide high force when in proximity to each other and lower force once angular separation of the opposing jaws have begun. In one embodiment, the magnets can be provided as a series of inserts within the base of the jaws on the opposite side of the pivot than the blades. In another embodiment, one of the two poles can be provided in the tool body. In both cases, because the repelling forces do not require exact alignment as in the case of a spring, there is an opportunity to offset the magnet locations in any direction. Further, the use of magnets in scissors enables the scissors to be used as a magnetic cleanup tool, magnetic retrieval device, or magnetic attachment and storage.

### FIELD OF THE INVENTION

The present invention relates to the field of tools and more particularly to the provision of counter force to scissors, pliers or other angular displacement mechanisms and which is especially advantageous in cases where miniaturization results in limited space is availability, a more limited manual manipulation capability and where ancillary magnetic characteristics can provide additional advantages and uses.

### BACKGROUND OF THE INVENTION

In larger displaceable tools, particularly scissors, the provision of a biasing force is advantageous. For very tiny pliers, the provision of an opening force which is counter to the manual grasping force can enable users in tight spaces to more exactly manipulate the tool without the need for re-positioning of the hands in order to open the tool. This is also particularly the case for scissors in which rapid movement over a narrow angle displacement is advantageous.

In larger scissors, a spring provided counter force has proved advantageous where large scale jamming would occur, such as for rose clippers and pruning shears. For larger finely engineered scissors, spring counter force has been provided to eliminate the full double action required for operation and to reduce the handle size and structures which would be employed in applying an opening force. Since the strength of manual gripping is greater than the strength involved in opening the hand, a spring bias in the direction of opening the scissors, pliers or other angularly displaceable members have enabled users to manipulate the scissors more rapidly and with greater comfort. This is particularly true for jobs requiring repetitive motion over a fairly well defined displacement range such as is the case for cutting.

Typically the spring action used for full sized scissors has been provided by a coil spring between a portion of the base handles. Where a linear spring is used, the structural controls on the ends of the springs have to be strong and sturdy enough to control the springs. In other cases a leaf coiled spring is used through twist action of the ends. In each of these cases, full scissors typically have enough clearance to enable a spring to be used without substantial interference with the hands or the operation of the scissors.

The spring action of this type is not limited to scissors and can be used in conjunction with pliers, tongs or other devices. However, where factors are added to scissors and scissor-like implements including (1) miniaturization, (2) expanded foldability to enable stowage and (3) limited ability for full “fingers versus thumb” action, the ability to use conventional spring structures is seriously challenged. The use of a spring link can interfere with stowage and retrieval. A spring link can be caught on other objects and easily bent or damaged. The provision of spring action in a safe manner and in a way without causing damage to the mechanism has been challenging.

In particular, these factors are typically present in foldable multi-tools. Where scissors are provided as a fold out deployable set, one side of the scissors typically pivot from a multi-tool handle, typically from a stored position where the blades are either closed or opened wide. In either of these configurations, any spring force would need to be configured to enable a completely open or completely closed position, and in some cases the ability to move between both positions without damage or reduced action of the spring is required.

Further, a scissors set in a multi tool must have a narrow profile in order to be able to fit in a narrow slot where the remainder of the space or spaces are occupied by other types of tools, either in the same slot or in adjacent slots.

Further, in the multi-tool environment, the smaller, narrower scissors are typically configured so that one leg of the scissors assumes a stable position with regard to the multi-tool handle and the other leg of the scissors is manipulated with the thumb of one hand. The scissors are closed with downward pressure of the thumb and typically opened with some spring device.

Some spring devices have been formulated to tease the thumb operated scissors half open with a lever rubbing action. The rubbing action typically is derived through a lever provided on one side of the scissor leg attached to the multi-tool. Thus the width which has to be provided for a scissor implement is double wide, one width to accommodate the scissor leg and an additional width to accommodate the rubbing spring member. The pivoting leg is typically double wide as the double wide space is simply already available.

In addition, the lever must also depend from another springing member on the multi-tool. As a result, a double width space and a dependence from a springing lever (also typically occupying a double spring space) must be occupied. What is therefore needed is a force method to enable the one-thumb operation of scissors in a multi-tool without taking up a double space width necessary to accommodate the spring lever.

### SUMMARY OF THE INVENTION

A scissors set includes magnetic elements to provide the force to open the scissor members, and are particularly useful for miniature, multi-tool use. With precision scissors, the force necessary to open the jaws is minimal. Further, the area of contact or overlap with scissors jaws is highest when closed and low once a few degrees of separation have occurred. The scissors disclosed herein use magnets to provide the force of separation. Opposing same-polarity magnets provide high force when in proximity to each other and lower force once angular separation of the opposing jaws have begun. Further, where the scissors set is stored, in either the stored or closed position, the magnet poles may be left exposed for other uses.

External magnetic field availability can be used for direction finding, drywall nail location, and other uses which may be enhanced by string, line or cord suspension of the multi-tool containing the magnetic operable angularly displaceable members. Where the magnetic operable angularly displaceable members can be stowably re-oriented to a same, attractive, rather than opposing orientation, the stowed multi-tool will have enhanced magnetic capability, mutually stabilizing magnetic storage capability, and increased stability in the stowed position.

In one embodiment, the magnets can be provided as a series of inserts within the base of the jaws on the opposite side of the pivot than the blades. In another embodiment, one of the two poles can be provided in the tool body. In both cases, because the repelling forces do not require exact alignment as in the case of a spring, there is an opportunity to offset the magnet locations in any direction. Further, the use of magnets in scissors enables the scissors to be used as a magnetic cleanup tool, magnetic retrieval device, or magnetic attachment and storage.

### BRIEF DESCRIPTION OF THE DRAWINGS

The invention, its configuration, construction, and operation will be best further described in the following detailed description, taken in conjunction with the accompanying drawings in which:

FIG. 1 is a view of a typical multi-tool and illustrating a variety of implements;

FIG. 2 is a view of a scissors set having magnets mounted in opposing, repulsive relationship with the same poles of the magnets in opposition to urge the scissor jaws to open position;

FIG. 3 is a closeup view taken along line 2-2 and illustrating a magnet insert;

FIG. 4 is an embodiment having a magnet insert in one of the handles or jaws and operating in opposition to a magnet mounted in the multi-tool housing or handle;

FIG. 5 is a closeup of the magnets shown in FIG. 4 in close relationship;

FIG. 6 illustrates a view similar to that of FIG. 5 but with the scissors set shown in a stowed relationship; and

FIG. 7 is a three dimensional view of magnetic inserts in the base jaws of a scissors set.

### DETAILED DESCRIPTION OF THE PREFERRED EMBODIMENT

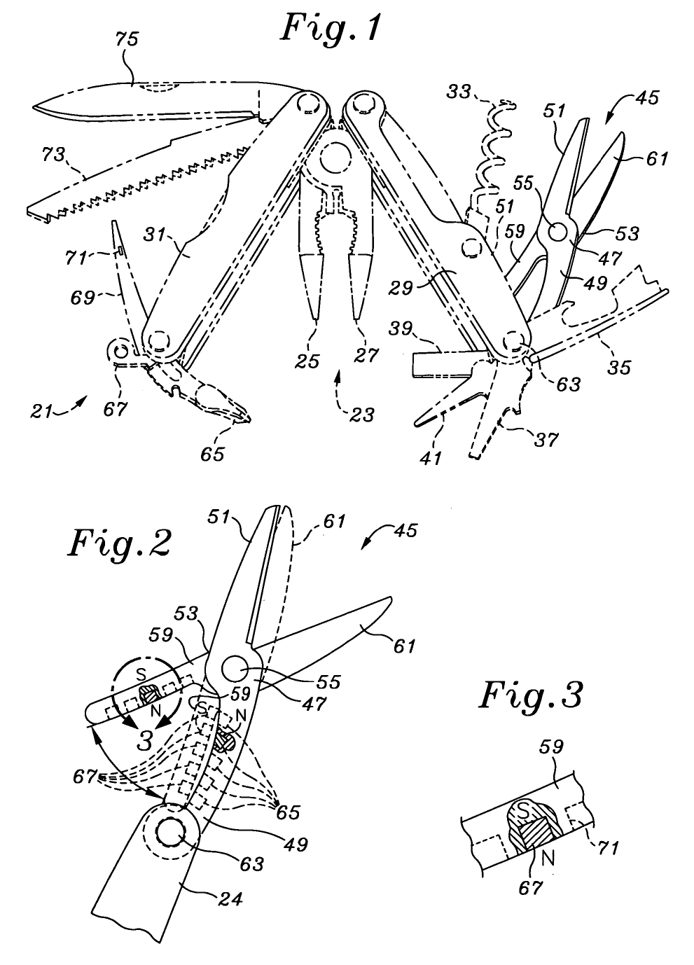

A multi-tool 21 is shown in FIG. 1. In one of the more popular styles, a central pliers set 23 has a first jaw 25 and second jaw 27, is provide between a pair of housing or handle members 29 and 31. To complete the multi-tool, handle 29 is associated with a corkscrew 33, bottle opener 35, flat head screw driver 37, flat head screw driver 39, and pick 41.

A scissors set 45 is provided having a member 47 having a handle portion 49 attached to the multi-tool 21 handle 28 and continuous with a cutting jaw 51. A member 53 has a pivot 55 attaching it to member 47. Member 53 has a handle portion 59 continuous with a cutting jaw 61. The scissors set 45 is not shown in its most extended position, where it would assume an operational position. Scissors set 45 pivots about a pivot 63 to enable it to be stowed at least partially within the handle 29. Stowage can be performed generally in either direction with the scissors set 45 being stowed with the cutting jaws 51 and 61 closed or in an open position with the cutting jaws 51 and 61 open. The configuration shown is more amenable to stowage in the closed position.

Multi-tool 21 handle 31 is associated with a Phillips head screw driver 65, an attachment ring 67, punch 69 with eyelet 71, saw 73, and knife 75. Typically the tools associated with the handles 29 and 31 can be utilized when the pliers set 23 is enclosed by the handles 29 and 31.

Referring to FIG. 2, a closeup of scissors set 45 is shown in an open position. Typically operation will be had by grasping handle 29 and operating handle portion 59 with the user's free thumb. Depressing the handle portion 59 with the thumb will cause the cutting jaws 51 and 61 to close. The dashed line format view shows cutting jaw 61 closed against cutting jaw 51.

When cutting jaw 61 is closed against cutting jaw 51, the handle portion 49 is moved adjacent handle portion 51. As can be seen handle portion 49 has a series of inserted or attached magnets 65, one of which is shown in a sectional view. Similarly handle portion 59 has a series of inserted or attached magnets 67, one of which is shown in a sectional view. The magnets 65 and 67 are arranged so that if the north pole of magnets 65 face the magnets 67 that the north pole of magnets 67 face the magnets 65.

The use of the terms magnets herein, including magnets 65 and 67 may be integrated into the materials supporting them. For example, the handle portions 49 and 59 may be magnetized with the appropriate polarity to cause them to operate the same way as individual magnets 65 and 67. Indeed, if handle portions 49 and 59 are ferromagnetic they are likely to become magnetized by the action of individual magnets 65 and 67. The term magnetic member refers to any structure used to generate a magnetic field.

The aspects shown in FIG. 3 emphasize a series of possibilities. The magnets 65 and 67 may, but need not opposingly align with each other. The magnets 65 and 67 may be one single magnet or a series of magnets. Given the repulsion force relationship of magnets, the handle portions 49 and 59 may enable the magnets 65 and 67 to touch or there may be a controlled space separating the magnets 65 and 67 when the handle portions 49 and 59 are brought close together.

It is should be further noted the proximity of magnets having opposite polarity will operate at a mechanical advantage depending upon the distance from the pivot 55. Opposing magnet pairs located farther from pivot 55 will exert more opening force to the cutting jaws 51 and 61, while opposing magnet pairs located closer to the pivot 55 will exert a lesser opening force to the cutting jaws 51 and 61. However, due to the fact that magnets exert a much higher force when in close proximity, as the handle portions 49 and 51 move angularly apart, the magnets 65 and 67 located farther from pivot 55 will cease exerting significant opposing force while the magnets located nearer to pivot 55 will continue to exert significant force, but at a lesser mechanical advantage.

As a result of these factors, magnets 65 and 67 can be distributed along the handle portions 49 and 51 to control the force bias related to the opening of the cutting jaws 51 and 61. Elements which can be varied include magnet size, magnet strength, and distribution. The magnets 65 and 67 can be adjusted to give a relatively constant opening force. The placement of magnets 65 and 67 can be combined to offer a higher opening force over the first few degrees of opening disclosure combined with a relatively constant opening force over the remainder of the angular displacement of the cutting jaws 51 and 61.

Referring to FIG. 3, an expanded view taken along line 3-3 of FIG. 2 illustrates a closeup view of one of magnets 67. The magnets 67, like the magnets 65, can be placed in an open space 71 and secured with glue, welding or other device to fix it in place. In the alternative, the open spaces 71 could be used to support a single long magnetic structure.

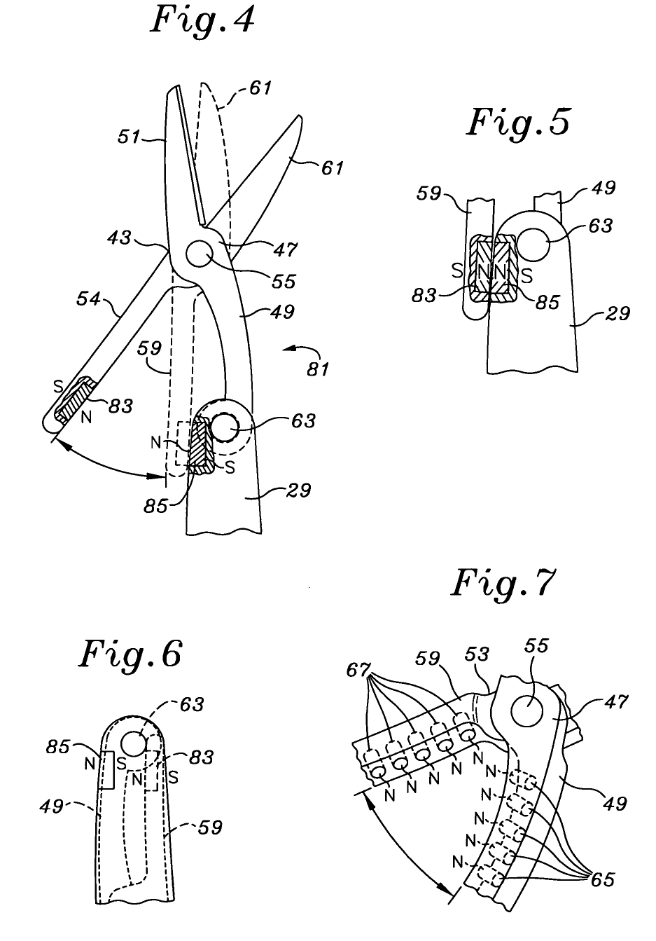

Referring to FIG. 4, a further embodiment is seen as a scissor set 81 having generally common structures with scissor set 45, but having a single magnet 83 located in the handle portion 59 and a single magnet 85 which is supported in the handle 29. This orientation may have several advantages.

First, the provision of stronger magnets 83 and 85 at a point farther from pivot 55 will provide an even higher force on immediate displacement from the close position with a rapid drop off of force as the angular displacement proceeds. This favors a manual cyclic operation of limited angular displacement especially with slight thumb action. Secondly, by providing a single magnet opposing pair distant from pivot 55 will enable an effective force over a narrower range of angular displacement of the cutting jaws 51 and 61 which approximates the main range of motion for cutting. Thirdly, by providing a single magnet opposing pair distant from pivot 55, one of the magnets shown, magnet 85 can be positioned in or adjacent the handle 29. Depending upon the mounting method and lateral placement of magnet 85, this can provide several potential benefits.

Where the magnet 85 is mounted laterally, the folding of the scissors set 81 can cause the magnet 83 to pass to one side of and through the force generated by the magnet 85 to end up on the other side of it in an attraction configuration to stabilize the scissors set 81 in the stowed position. Thus in stowage position, the magnets 83 and 85 are oriented to increase their magnetic force, and to provide some external (enhanced) magnetic force.

Referring to FIG. 5, the a closeup of the opposing force relationship of magnets 83 and 85 are shown. Where mounted adjacent to the slot which accommodates the handle portion 59, the handle portion 59 can continue farther into such slot (not shown) until it engages the pivot 63. Where sufficient clearance is had, the handle portion 59 can fold around the pivot 63 and magnet 83 can assume a synergistic force relationship with magnet 85. Referring to FIG. 6, this relationship is illustrated.

Referring to FIG. 7, a three dimensional relationship between the handle portions 49 and 59 are shown. In FIG. 2, the scissors set 45 as shown in a plan view suggests that the members 47 and 53 may be formed from plates of material of common thickness. Indeed, the opposing magnetic force can be had when the magnets 65 and 67 are not immediately lined up and they may be laterally adjacent each other. In this configuration they might be allowed to pass but for some other interfering member. This is usually the case also for conventional scissors.

However, the handle portions 49 and 59 may be laterally widened to each occupy a width which is roughly equivalent to the width occupied at the pivot 55. Each of the members 47 and 53 at the pivot 55 and continuing to the cutting jaws 51 and 51 may be only half of the total thickness occupied at the pivot 55. As each of the members 47 and 45 extend into their respective handle portions 49 and 59, the width of the handle portions 49 and 59 may be expanded both to provide a natural stop against each other, a naturally wider support into which magnets 65 and 67 may be positioned, and a wider handle portion 59 for manual engagement.

While the present invention has been described in terms of a structure into which magnets may be placed to produce counter force, and to enable much more exacting force control of miniaturized and non-miniaturized implements, the present invention may be applied in any situation where operational counter-force control is desired without the use of complicated, space-occupying mechanical linkages which lessens the reliability, and unwarrantedly increases the complexity of small implements, particularly multi-tools.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

1. An angular displacement system comprising:
a first member having a first jaw portion, and a first handle portion and a pivoting connection between said first jaw portion and said first handle portion;
a second member having a second jaw portion, and a second handle portion with said pivoting connection between said second jaw portion and said second handle portion, said second member pivotally displaceable about said pivoting connection with respect to said first member;
a first magnetic member supported by said first handle portion having a first polarity; and
a second magnetic member having a polarity in opposition to said first magnetic member and located with respect to said second handle portion to exert a repulsive force on said first magnetic member to cause said first jaw portion to open with respect to said second jaw portion.

2. The angular displacement system as recited in claim 1 and further comprising a tool handle, and wherein said second member is supported by said tool handle.

3. The angular displacement system as recited in claim 2 and wherein said second member is pivotally deployable with respect to said tool handle.

4. The angular displacement system as recited in claim 2 and wherein said second magnetic member is supported by said tool handle.

5. The angular displacement system as recited in claim 1 and wherein said second magnetic member is supported by said second handle member.

6. The angular displacement system as recited in claim 1 and wherein said first and said second jaws are scissor jaws and form a scissors set.

7. The angular displacement system as recited in claim 2 and wherein said tool handle supports at least one other tool member than said angular displacement system.

8. The angular displacement system as recited in claim 7 and wherein at least one of said first and said second magnet members are available externally when said angular displacement system is stowed with respect to said tool handle.
